(19) United States
(12) Patent Application Publication
(10) Pub. No.: US 2003/0037822 A1
(43) Pub. Date: Feb. 27, 2003

(54) Check valve for fuel pump

(76) Inventors: John G. Fischer, Goodrich, MI (US); Robert A. Roth, Grand Blanc, MI (US)

Correspondence Address: VINCENT A. CICHOSZ, DELPHI TECHNOLOGIES, INC., Legal Staff, P.O. Box 5052 Mail Code: 480-414-420, Troy, MI, 48007-5052, US

(21) Appl. No.: 09/935,079

(22) Filed: Aug. 22, 2001

(51) Int. Cl. F16K 17/00

(52) U.S. Cl. 137/528

(57) ABSTRACT

A check valve for a fuel pump of a vehicle includes a retainer adapted to be disposed in an outlet member of the fuel pump. The check valve also includes a valve seat adapted to be disposed in the outlet member and spaced from the retainer. The check valve includes a valve member disposed in the outlet member between the retainer and the valve seat. The valve member has a closed position to engage the valve seat to prevent fuel from flowing through the outlet member and an open position to allow fuel to flow through the outlet member. The check valve further includes a magnet cooperating with the valve member for generating a magnetic force on the valve member to maintain a contact force between the valve member and the valve seat when the valve member is in the closed position.

### TECHNICAL FIELD

The present invention relates generally to fuel pumps for vehicles and, more particularly, to a check valve for a fuel pump of a vehicle.

### BACKGROUND OF THE INVENTION

It is known to provide a fuel tank in a vehicle to hold fuel to be used by an engine of the vehicle. It is also known to provide a fuel pump inside the fuel tank to pump fuel to the engine. Typically, the fuel pump includes a check valve to allow fuel to exit the fuel pump. Generally, a forward flow check valve consists of a checking device, typically a plunger, and a seat that when in contact form a leak proof seal. The plunger is forced against the seat with a spring that provides the proper force to maintain plunger to seat contact during low-pressure forward flow conditions. In automotive fuel pump applications, this force prevents flow from exiting the fuel tank when the vehicle fuel line is removed or severed. Linear springs have been used to apply sealing force between the plunger and seat. This force increases as the plunger travels away from the seat. The spring force required to maintain sealing during low-pressure forward flow conditions also creates an undesired flow restriction during high-pressure forward flow conditions. To develop a low restriction flow path, the plunger must travel in the flow direction away from the seat. This creates a larger, less restrictive flow area between the seat and plunger. However, as the plunger travels away from the seat, the linear characteristic of the coil spring imparts additional force on the plunger and acts to resist the desirable increase in flow area.

Therefore, it is desirable to provide a check valve in a fuel pump for a vehicle that produces the required contact force in the closed position but reduces the counteracting force in the open position. It is also desirable to provide a check valve for a fuel pump without compromising low flow restriction. It is further desirable to provide a check valve for a fuel pump at a relatively low cost.

### SUMMARY OF THE INVENTION

It is, therefore, one object of the present invention to provide a new check valve for a fuel pump of a vehicle.

It is another object of the present invention to provide a check valve for a fuel pump that provides a mechanism to produce a required plunger to seat contact force in the closed position but reduces the counteracting force in the open position.

It is yet another object of the present invention to provide a check valve for a fuel pump that has relatively low flow restriction.

To achieve the foregoing objects, the present invention is a check valve for a fuel pump of a vehicle including a retainer adapted to be disposed in an outlet member of the fuel pump. The check valve also includes a valve seat adapted to be disposed in the outlet member and spaced from the retainer. The check valve includes a valve member disposed in the outlet member between the retainer and the valve seat. The valve member has a closed position to engage the valve seat to prevent fuel from flowing through the outlet member and an open position to allow fuel to flow through the outlet member. The check valve further includes a magnet cooperating with the valve member for generating a magnetic force on the valve member to maintain a contact force between the valve member and the valve seat when the valve member is in the closed position.

One advantage of the present invention is that a new check valve is provided for a fuel pump of a vehicle. Another advantage of the present invention is that the check valve has a magnetic force acting on a plunger, which reduces as the plunger travels away from the valve seat, allowing an increase in flow area to provide low flow restriction. Yet another advantage of the present invention is that the check valve has a magnet to produce the required plunger to seat contact force in the closed position, but reduces the counteracting force in the open position. Still another advantage of the present invention is that the check valve has a relatively low flow restriction and improves fuel pump performance and efficiency. A further advantage of the present invention is that the check valve meets higher forward flow shut-off performance and higher pump capability due to less restriction and more flow.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a fragmentary elevational view of a check valve, according to the present invention, illustrated in operational relationship with a fuel pump.

FIG. 2 is an enlarged fragmentary elevational view of the check valve of FIG. 1 illustrating a closed position.

FIG. 3 is a view similar to FIG. 2 illustrating an open position of the check valve.

FIG. 4 is an enlarged fragmentary elevational view of another embodiment, according to the present invention, of the check valve of FIG. 1 illustrating a closed position.

FIG. 5 is a view similar to FIG. 4 illustrating an open position of the check valve.

FIG. 6 is an enlarged fragmentary elevational view of yet another embodiment, according to the present invention, of the check valve of FIG. 1 illustrating a closed position.

FIG. 7 is a view similar to FIG. 6 illustrating an open position of the check valve.

### DESCRIPTION OF THE PREFERRED EMBODIMENT

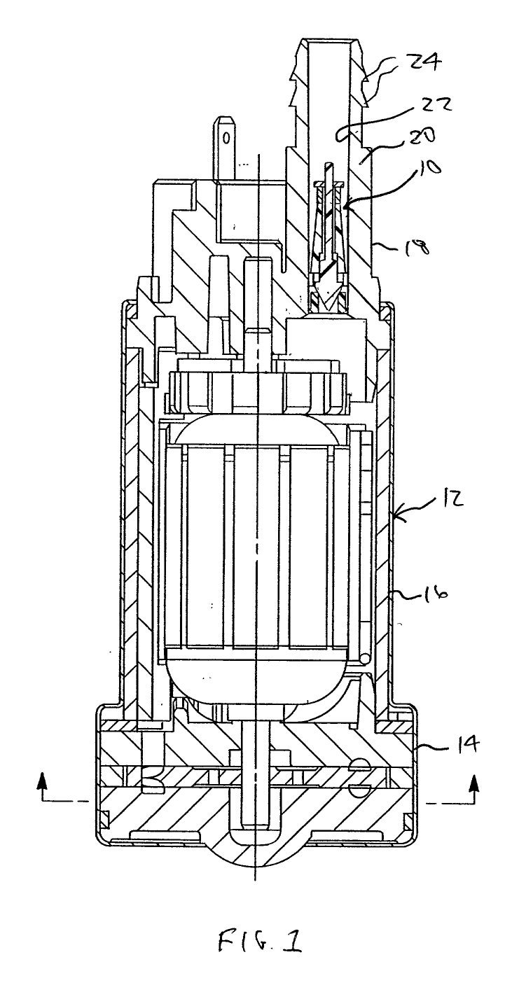

Referring to the drawings and in particular FIGS. 1 through 3, one embodiment of a check valve 10, according to the present invention, is shown for a fuel pump, generally indicated at 12, of a vehicle (not shown). The fuel pump 12 includes a pump section 14 at one axial end, a motor section 16 adjacent the pump section 14 and an outlet section 18 adjacent the motor section 16 at the other axial end. As known in the art, fuel enters the pump section 14, which is rotated by the motor section 16, and is pumped past the motor section 16 to the outlet section 18. The outlet section 18 has an outlet member 20 extending axially with a passageway 22 extending axially therethrough. The outlet member 20 also has a plurality of projections or barbs 24 extending radially outwardly for attachment to a conduit (not shown). The outlet member 20 also receives the check valve 10 to be described in the passageway 22. It should be appreciated that the fuel flowing to the outlet section 18 flows into the outlet member 20 and through the passageway 22 and the check valve 10 when open to the conduit. It should also be appreciated that, except for the check valve 10, the fuel pump 12 is conventional and known in the art.

Referring to FIGS. 1 through 3, the check valve 10 includes a retainer 26 extending axially and disposed in the passageway 22 of the outlet member 20. The retainer 26 has a body portion 28 that is generally tubular in shape and has a generally frusta-conical cross-sectional shape. The body portion 28 extends axially and has a passageway 29 extending axially therethrough with a stepped enlarged portion 29a at one end. The body portion 28 also has at least one, preferably a plurality of apertures 30 extending diametrically therethrough and communicating with the enlarged portion 29a of the passageway 29. The retainer 26 is made of a rigid material such as plastic and formed by suitable molding processes such as injection molding. It should also be appreciated that the retainer 26 is a monolithic structure being integral, unitary, and one-piece.

The check valve 10 also includes a magnet 32 disposed at one end of the retainer 26. The magnet 32 is generally tubular in shape and has a generally circular cross-sectional shape. The magnet 32 extends axially and has an aperture 34 extending axially therethrough for a function to be described. The aperture 34 has a generally circular cross-sectional shape. The magnet 32 is made of a magnetic material. The magnet 32 is connected to the retainer 26 by suitable means such as an adhesive. It should be appreciated that the magnet 32 is a monolithic structure being integral, unitary, and one-piece.

The check valve 10 includes a valve seat 36 disposed in the passageway 22 adjacent the other end of the retainer 26 and spaced axially therefrom. The valve seat 36 has a body portion 38 that is generally cylindrical in shape with a generally circular cross-sectional shape. The valve seat 36 also has an aperture 40 extending axially through the body portion 38. The valve seat 36 has a recess 42 at one end thereof communicating with the aperture 40 for a function to be described. The valve seat 36 also has a flange 44 extending radially from the body portion 38 and disposed annularly thereabout to engage a surface of the passageway 22 of the outlet member 20. The valve seat 36 is made of a rigid material such as plastic and formed by suitable processes such as injection molding. It should be appreciated that the valve seat 36 may have an enlarged opening (not shown) in the aperture 40 opposite the recess 42.

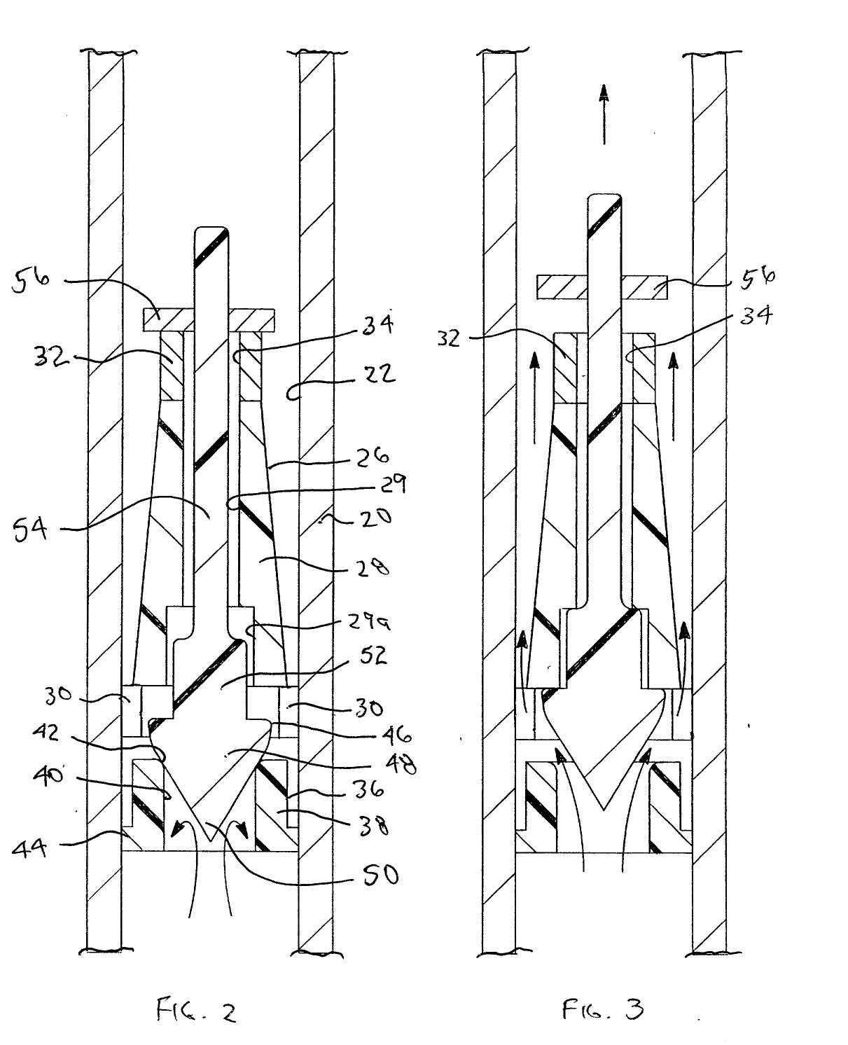

The check valve 10 also includes a valve member 46 disposed between the retainer 26 and the valve seat 36 and cooperating therewith. The valve member 46 is of a plunger type and extends axially. The valve member 46 has a hub 48 with a tip 50. The hub 48 has a conical shape. The tip 50 has a cone shape with an inclusive angle of a predetermined amount such as sixty degrees (60°). The tip 50 extends into the aperture 40 of the valve seat 36 and engages the recess 42 in a closed position. The valve member 46 has a reduced diameter portion 52 extending axially from the hub 48 opposite the tip 50. The reduced diameter portion 52 is generally cylindrical in shape with a generally circular cross-sectional shape. The valve member 46 also has a stem 54 extending axially from the reduced diameter portion 52. The stem 54 is generally cylindrical with a generally circular cross-sectional shape. The stem 54 is disposed in the passageway 29 of the retainer 26 for sliding movement therein. The stem 54 has a length to diameter ratio greater than a predetermined amount such as four (4) to provide balance between valve length and stem diameter, resulting in better stability and/or reduction of wobble/rattle in the fluid stream. The valve member 46 has a first or closed position engaging the valve seat 36 to close the aperture 40 of the valve seat 36 as illustrated in FIG. 2. The valve member 46 has a second or open position cooperating with the retainer 26 to open the aperture 40 in the valve seat 36 as illustrated in FIG. 3. The valve member 46 is made of a non-magnetic rigid material such as plastic. It should be appreciated that fluid such as fuel flows through the aperture 40 in the valve seat 36, past the valve member 46 and out the apertures 30 and through the passageway 22 when the valve member 46 is in the open position as illustrated in FIG. 3.

The check valve 10 further includes a clip 56 at one end of the valve member 46. The clip 56 is of a disk type. The clip 56 is made of a ferromagnetic material such as steel. The clip 56 is disposed about the stem 54 of the valve member 46 adjacent the magnet 32. It should be appreciated that the magnet 32 attracts the clip 56 to urge the tip 50 of the hub 48 to engage the recess 42 of the valve seat 36 in a closed position. It should also be appreciated that the magnetic force on the clip 56 maintains the force between the valve member 46 and the valve seat 36.

In operation, the check valve 10 is illustrated in an assembled state in which the retainer 26 is disposed in the passageway 22 of the outlet member 20 of the fuel pump 12 and the magnet 32 is charged. The valve member 46 engages the valve seat 36 in the closed position as illustrated in FIG. 2. The valve member 46 is contained on the valve seat 36 by the magnetic force between the clip 56 and the magnet 32.

During high forward flow conditions, the valve member 50 is dislodged from the seated position and travels in the flow direction away from the valve seat 36. Fuel enters the outlet member 20 when the fuel is pumped by the pump section 14 past the motor section 16 to the outlet section 18. In normal operating conditions where the flow of the fuel pump 12 is greater than 20 kPa. to the check valve 10, fuel flows, as indicated by the arrow in FIG. 3, to the aperture 40 in the valve seat 36 and causes the valve member 46 to move from the recess 42 in the valve seat 36. The magnetic force acting against the movement of the valve member 46 reduces at a cubic function with separation distance. Therefore, the force acting against the valve member 46 is quickly reduced with respect to forward travel of the valve member 46. The valve member 46 moves to an open position when the fuel flow and pressure force on the valve member 46 exceeds the magnetic force between the magnet 32 and clip 56, which is the maximum position desired off of the valve seat 36. In the open position, the valve member 46 allows fuel to flow through the aperture 40 and around the hub 48 of the valve member 46 and out through the apertures 30. Fuel flows from the check valve 10 through the passageway 22 of the outlet member 20 to the conduit. In the open position, the valve member 46 is contained and retained in the center of the fuel flow stream by the retainer 26, which guides the stem 54 of the valve member 46. The valve member 46 is limited in axial movement by the retainer 26 due to the reduced diameter portion 52 contacting the end of the enlarged portion 29a of the passageway 29 of the retainer 26. At low flow conditions, the position of the valve member 46 is determined by the magnetic force and distance of the valve member 46 off of the valve seat 36. It should be appreciated that the magnet 32 and clip 56 allow the valve member 50 to move away from the valve seat 36 and into its fully stopped position at lower flow rates than conventional springs. It should also be appreciated that the magnet gauss level and position of the clip 56 can be designed or adjusted to produce the desired seating force.

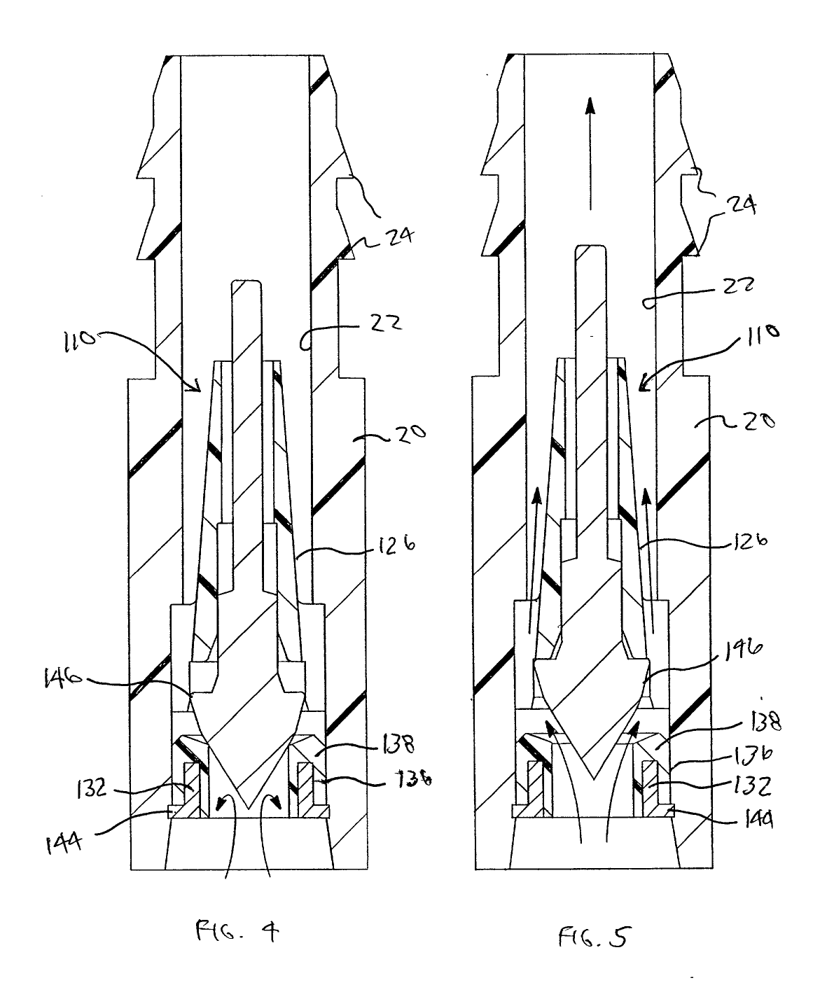

Referring to FIGS. 4 and 5, another embodiment, according to the present invention, of the check valve 10 is shown. Like parts of the check valve 10 have like reference numerals increased by one hundred (100). In this embodiment, the check valve 110 includes the retainer 126, magnet 132, valve seat 136, and valve member 146, but eliminates the clip. The check valve 110 includes the magnet 132 disposed in the valve seat 136. The valve seat 136 is made of an elastomeric material and the magnet 132 is disposed in the body 138 of the valve seat 136. The magnet 132 also forms the flange 144 of the valve seat 136. The check valve 110 also includes the plunger 146 made of a ferromagnetic or iron based material such as steel. The magnetic force on the valve member 146 maintains force between the valve member 146 and the valve seat 136. The operation of the check valve 110 is similar to the operation of the check valve 10.

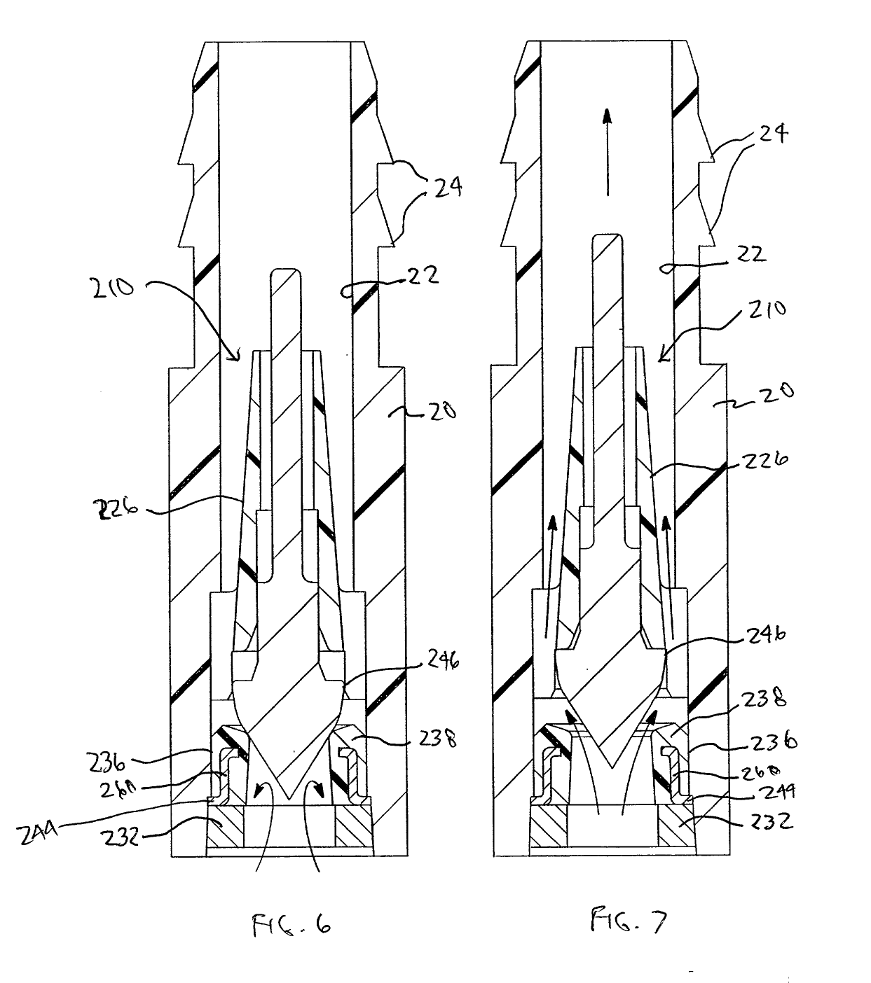

Referring to FIGS. 6 and 7, yet another embodiment, according to the present invention, of the check valve 10 is shown. Like parts of the check valve 10 have like reference numerals increased by two hundred (200). In this embodiment, the check valve 210 includes the retainer 226, magnet 232, valve seat 236, and valve member 246, but eliminates the clip. The check valve 210 includes the magnet 232 disposed adjacent the valve seat 236 on the other side or opposite the valve member 246. The check valve 210 also includes an insert 260 disposed in the valve seat 236. The valve seat 236 is made of an elastomeric material and the insert 260 is disposed in the body 238 of the valve seat 236. The insert 260 also forms the flange 244 of the valve seat 236. The insert 260 is made of a ferromagnetic or iron based material such as steel. The check valve 210 also includes the plunger 246 made of a ferromagnetic or iron based material such as steel. The magnetic force on the valve member 246 maintains force between the valve member 246 and the valve seat 236. The operation of the check valve 210 is similar to the operation of the check valve 10. It should be appreciated that the magnet 232 is in contact or close proximity to the valve seat 236 on the side opposite the valve member 246 and acts to magnetize the insert 260 within the valve seat 236 and produce a sealing force on the valve member 246.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. A check valve for a fuel pump of a vehicle comprising:
a retainer adapted to be disposed in an outlet member of the fuel pump;
a valve seat adapted to be disposed in the outlet member and spaced from said retainer; and
a valve member adapted to be disposed in the outlet member between said retainer and said valve seat and having a closed position to engage said valve seat to prevent fuel from flowing through the outlet member and an open position to allow fuel to flow through the outlet member;
a magnet cooperating with said valve member for generating a magnetic force on said valve member to maintain a contact force between said valve member and said valve seat when said valve member is in said closed position.

2. A check valve as set forth in claim 1 wherein said magnet is disposed at one end of said retainer.

3. A check valve as set forth in claim 2 including a clip connected to said valve member and disposed adjacent said magnet.

4. A check valve as set forth in claim 2 wherein said clip is made of a ferromagnetic material.

5. A check valve as set forth in claim 2 wherein said valve member is made of a non-magnetic material.

6. A check valve as set forth in claim 1 wherein said magnet is disposed in said valve seat.

7. A check valve as set forth in claim 6 wherein said valve member is made of a ferromagnetic material.

8. A check valve as set forth in claim 6 wherein said valve seat is made of an elastomeric material.

9. A check valve as set forth in claim 1 wherein said magnet is disposed adjacent said valve seat on a side opposite said valve member.

10. A check valve as set forth in claim 9 including an insert disposed in said valve seat.

11. A check valve as set forth in claim 10 wherein said insert is made of a ferromagnetic material.

12. A check valve as set forth in claim 9 wherein said valve member is made of a ferromagnetic material.

13. A check valve as set forth in claim 9 wherein said valve seat is made of an elastomeric material.

14. A check valve as set forth in claim 1 wherein said valve member has a hub and a stem extending axially from said hub.

15. A check valve as set forth in claim 14 wherein said retainer has a passageway extending axially therethrough to receive said stem and guide said stem in said passageway.

16. A check valve as set forth in claim 15 wherein said valve member has a reduced diameter portion extending axially from said hub and said retainer has a enlarged opening at one end of said passageway to receive said reduced diameter portion and limit axial movement of said valve member in said open position.

17. A check valve for a fuel pump of a vehicle comprising:
a retainer adapted to be disposed in an outlet member of the fuel pump, said retainer having a passageway extending axially therethrough;
a valve seat adapted to be disposed in the outlet member and spaced axially from said retainer;
a valve member having a hub and a stem extending axially from said hub, said valve member adapted to be disposed in said outlet member with said stem extending through said passageway, said hub having a closed position to engage said valve seat to prevent fuel from flowing through the outlet member and an open position to allow fuel to flow through the outlet member; and
a magnet cooperating with said valve member for generating a magnetic force on said valve member to maintain a contact force between said valve member and said valve seat when said valve member is in said closed position.

18. A check valve as set forth in claim 17 wherein said magnet is disposed at one end of said retainer.

19. A check valve as set forth in claim 18 including a clip connected to said valve member and disposed adjacent said magnet.

20. A check valve as set forth in claim 19 wherein said clip is made of a ferromagnetic material.

21. A check valve as set forth in claim 20 wherein said valve member is made of a non-magnetic material.

22. A check valve as set forth in claim 17 wherein said magnet is disposed in said valve seat.

23. A check valve as set forth in claim 22 wherein said valve member is made of a ferromagnetic material.

24. A check valve as set forth in claim 23 wherein said valve seat is made of an elastomeric material.

25. A check valve as set forth in claim 17 wherein said magnet is disposed adjacent said valve seat on a side opposite said valve member.

26. A check valve as set forth in claim 25 including an insert disposed in said valve seat.

27. A check valve as set forth in claim 26 wherein said insert is made of a ferromagnetic material.

28. A check valve as set forth in claim 27 wherein said valve member is made of a ferromagnetic material.

29. A check valve as set forth in claim 28 wherein said valve seat is made of an elastomeric material.

30. A check valve for a fuel pump of a vehicle comprising:
a retainer adapted to be disposed in an outlet member of the fuel pump;
a valve seat adapted to be disposed in the outlet member and spaced from said retainer; and
a valve member made of a non-magnetic material and adapted to be disposed in the outlet member between said retainer and said valve seat and having a closed position to engage said valve seat to prevent fuel from flowing through the outlet member and an open position to allow fuel to flow through the outlet member;
a magnet disposed at one end of said retainer and a clip made of a ferromagnetic material connected to said valve member and disposed adjacent said magnet, said magnet generating a magnetic force on said clip to maintain a contact force between said valve member and said valve seat when said valve member is in said closed position.

31. A check valve for a fuel pump of a vehicle comprising:
a retainer adapted to be disposed in an outlet member of the fuel pump;
a valve seat adapted to be disposed in the outlet member and spaced from said retainer; and
a valve member made of a ferromagnetic material and adapted to be disposed in the outlet member between said retainer and said valve seat and having a closed position to engage said valve seat to prevent fuel from flowing through the outlet member and an open position to allow fuel to flow through the outlet member;
a magnet disposed in said valve seat for generating a magnetic force on said valve member to maintain a contact force between said valve member and said valve seat when said valve member is in said closed position.

32. A check valve for a fuel pump of a vehicle comprising:
a retainer adapted to be disposed in an outlet member of the fuel pump;
a valve seat adapted to be disposed in the outlet member and spaced from said retainer; and
a valve member made of a ferromagnetic material and adapted to be disposed in the outlet member between said retainer and said valve seat and having a closed position to engage said valve seat to prevent fuel from flowing through the outlet member and an open position to allow fuel to flow through the outlet member;
an insert made of a ferromagnetic material disposed in said valve seat; and
a magnet disposed adjacent said valve seat on a side opposite said valve member for generating a magnetic force on said valve member to maintain a contact force between said valve member and said valve seat when said valve member is in said closed position.
